(19) United States
(12) Patent Application Publication
(10) Pub. No.: US 2024/0053210 A1
(43) Pub. Date: Feb. 15, 2024

(54) SENSOR DEVICE

(71) Applicant: Murata Manufacturing Co., Ltd., Nagaokakyo-shi (JP)

(72) Inventors: Hiroshi WATANABE, Nagaokakyo-shi (JP); Kohei SUGAHARA, Nagaokakyo-shi (JP); Takatoshi KATO, Nagaokakyo-shi (JP); Koichi INOUE, Nagaokakyo-shi (JP)

(21) Appl. No.: 18/382,094

(22) Filed: Oct. 20, 2023

Related U.S. Application Data
(63) Continuation of application No. PCT/JP2022/011714, filed on Mar. 15, 2022.

(30) Foreign Application Priority Data
Apr. 28, 2021 (JP) 2021-076433

(51) Int. Cl. G01L 1/00; G01S 7/481; G01S 17/08

(52) U.S. Cl. CPC G01L 1/005; G01S 7/4815; G01S 7/4816; G01S 17/08

(57) ABSTRACT

A sensor device includes a substrate, a force sensor on the substrate, and a proximity sensor including light emitting elements on the substrate and light receiving elements to receive light from the light emitting elements. At least one of the light emitting elements and the light receiving elements of the proximity sensor is located at three or more positions that surround the force sensor on the substrate. A position of a center of gravity with respect to the three or more positions is within a range in which the force sensor is positioned on the substrate.

### CROSS REFERENCE TO RELATED APPLICATIONS

This application claims the benefit of priority to Japanese Patent Application No. 2021-076433 filed on Apr. 28, 2021 and is a Continuation Application of PCT Application No. PCT/JP2022/011714 filed on Mar. 15, 2022. The entire contents of each application are hereby incorporated herein by reference.

### BACKGROUND OF THE INVENTION

### 1. Field of the Invention

The present invention relates to a sensor device that detects a force and proximity of a physical object, the force being produced by contact by the physical object.

### 2. Description of the Related Art

In recent years, various types of sensors that are mounted on a robot hand or the like, and that are capable of various sensing operations, such as sensing proximity of or contact by a physical object, have been proposed (for example, Japanese Unexamined Patent Application Publication No. 2007-071564, Japanese Patent No. 5825604 and International Publication No. 2014/045685).

Japanese Unexamined Patent Application Publication No. 2007-071564 discloses an optical tactile proximity sensor that detects a force that acts from the outside. The optical tactile proximity sensor includes a plurality of light emitting diodes; a plurality of light emitting diodes that can be switchably set between a light emission mode and a light reception mode; a light propagation medium that causes light from a light emitting diode in the light emission mode to propagate to a light emitting diode in the light reception mode, and that is compressively deformed by the force acting from the outside to change its light propagation characteristics; measuring means for measuring a light reception amount of the light emitting diode in the light reception mode; and arithmetic means for calculating, on the basis of the measured light reception amount, the magnitude of a force that acts upon the light propagation medium or its position. In addition, proximity of an object is detected by a structure from which a light propagation layer in the optical tactile proximity sensor is removed.

Japanese Patent No. 5825604 discloses an optical tactile sensor that is capable of a six-axis force measurement. International Publication No. 2014/045685 discloses a force sensor that detects a shear force by using a variable frame. In Japanese Patent No. 5825604 and International Publication No. 2014/045685, in an optical mechanism that makes use of deformation of an elastic body, sensing operations of various types of contact forces of a physical object are performed.

### SUMMARY OF THE INVENTION

In the tactile proximity sensor disclosed in Japanese Unexamined Patent Application Publication No. 2007-071564, an individual entity that functions as a tactile sensor and an individual entity that functions as a proximity sensor are constituted as separated entities. In such a related art, it is difficult to perform both detection of a force of a physical object and detection of proximity of the physical object by using one device.

Preferred embodiments of the present invention provide sensor devices that each detect a force of a physical object and easily detect a close physical object in various directions.

A sensor device according to a preferred embodiment of the present invention includes a substrate, a force sensor on the substrate, and a proximity sensor that includes a plurality of light emitting elements on the substrate and a plurality of light receiving elements to receive light from the light emitting elements. At least one of the plurality of light emitting elements and the plurality of light receiving elements of the proximity sensor is located at three or more positions that surround the force sensor on the substrate. A position of a center of gravity with respect to the three or more positions is within a range in which the force sensor is positioned on the substrate.

According to the sensor devices according to preferred embodiments of the present invention, it is possible to, in addition to detecting a force of a physical object, easily detect a close physical object in various directions.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of an outline drawing of a sensor device according to a first preferred embodiment of the present invention.

FIG. 2 is a plan view of the sensor device according to the first preferred embodiment of the present invention.

FIG. 3 is a side view of the sensor device according to the first preferred embodiment of the present invention.

FIG. 4 is a circuit diagram that exemplifies a structure of the sensor device according to the first preferred embodiment of the present invention.

FIG. 5 is a flowchart that exemplifies an operation of the sensor device according to the first preferred embodiment of the present invention.

FIG. 6 is a plan view of a sensor device according to a second preferred embodiment of the present invention.

FIG. 7 is a sectional view of the sensor device in FIG. 6.

FIG. 8 is a circuit diagram that exemplifies a structure of the sensor device according to the second preferred embodiment of the present invention.

FIG. 9 is a plan view showing a sensor device of Modification 1 of a preferred embodiment of the present invention.

FIG. 10 is a plan view showing a sensor device of Modification 2 of a preferred embodiment of the present invention.

FIG. 11 is a plan view showing a sensor device of Modification 3 of a preferred embodiment of the present invention.

### DETAILED DESCRIPTION OF THE PREFERRED EMBODIMENTS

Sensor devices according to preferred embodiments of the present invention are described below with reference to the attached drawings.

Each preferred embodiment is an exemplification, and the structures of different preferred embodiments can be partly replaced or combined. With regard to a second preferred embodiment and subsequent preferred embodiments, descriptions of matters that are common to those of the first preferred embodiment are omitted and only points that differ from those of the first preferred embodiment are described. In particular, the same operational effects resulting from similar structures are not described one at a time for each preferred embodiment.

### First Preferred Embodiment

### 1. Structure

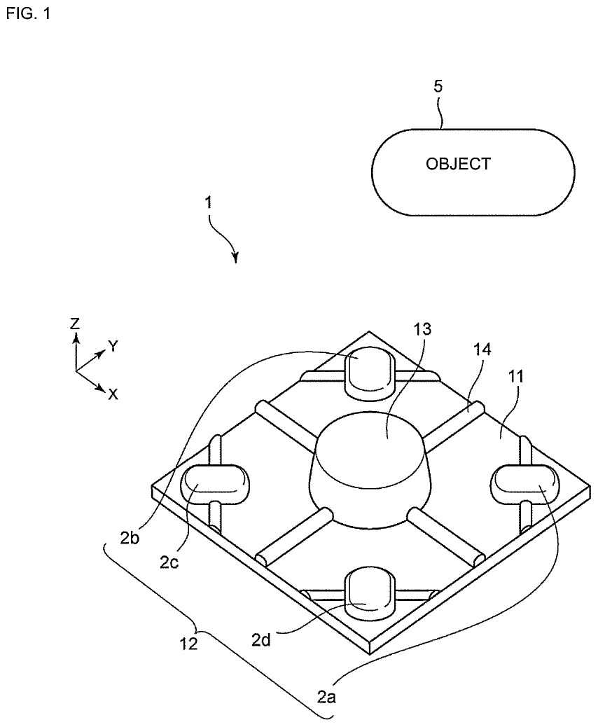

A structure of a sensor device according to a first preferred embodiment is described with reference to FIG. 1. FIG. 1 is a perspective view of an outline drawing of a sensor device 1 according to the first preferred embodiment.

The sensor device 1 of the present preferred embodiment is a sensor module in which, in an optical detection system, a proximity sensor 12 that detects proximity of an object 5 and a force sensor 13 that detects a force (that is, a contact force) that acts by contact by an object 5 are integral. The sensor device 1 is applicable to, for example, detection of, as an object 5, various types of physical bodies to be grasped in a robot hand. In addition, the sensor device 1 is applicable to an input interface that conveys various instructions and intentions of human beings to machines or devices in a human machine interface.

The sensor device 1 of the present preferred embodiment is capable of, by using the proximity sensor 12 and the force sensor 13, continuously detecting a series of processes in which the object 5 comes close to and contacts the sensor device 1 and a force is caused to act upon the sensor device 1. The sensor device 1 includes, for example, assembling the proximity sensor 12 and the force sensor 13 on a substrate 11. Hereunder, two directions that are parallel to a main surface of the substrate 11 are an X direction and a Y direction, and a normal direction to the main surface is a Z direction. A +Z side toward which the force sensor 13 protrudes from the substrate 11 may be called an upper side, and a −Z side that is an opposite side may be called a lower side.

In the sensor device 1 of the present preferred embodiment, the proximity sensor 12 includes a plurality of light receiving-emitting portions 2a to 2d that are disposed so as to surround the force sensor 13 on the substrate 11. By using the plurality of light receiving-emitting portions 2a to 2d of such a proximity sensor 12, the sensor device 1 of the present preferred embodiment is capable of, in addition to detecting a force of the force sensor 13, detecting proximity of the object 5 by, for example, not only being capable of detecting the distance from the sensor device 1 to the object 5 in the Z direction, but also being capable of detecting the direction of the object 5 when viewed from the sensor device 1 in an XY plane.

A structure of the sensor device 1 according to the present preferred embodiment is described in detail below. In the present preferred embodiment, an example in which the proximity sensor 12 includes four light receiving-emitting portions 2a, 2b, 2c, and 2d is described.

### 1-1. Structure of Sensor Device

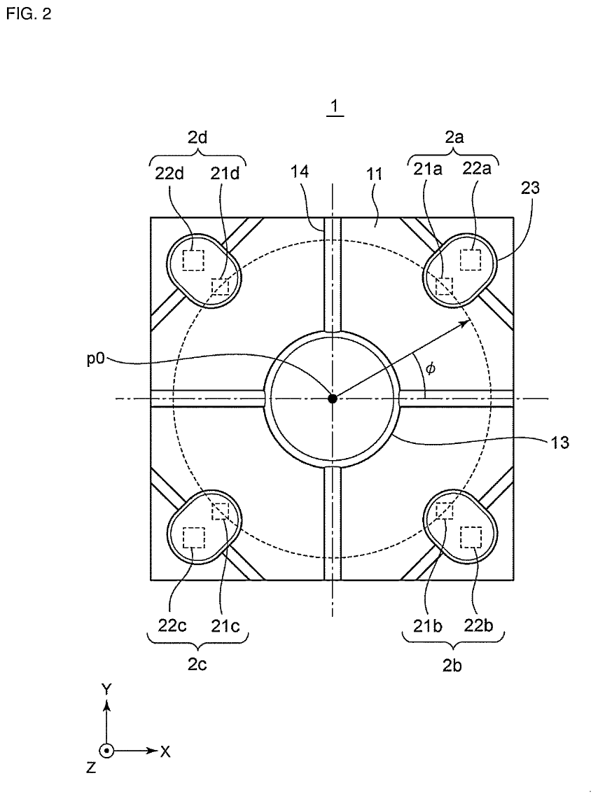

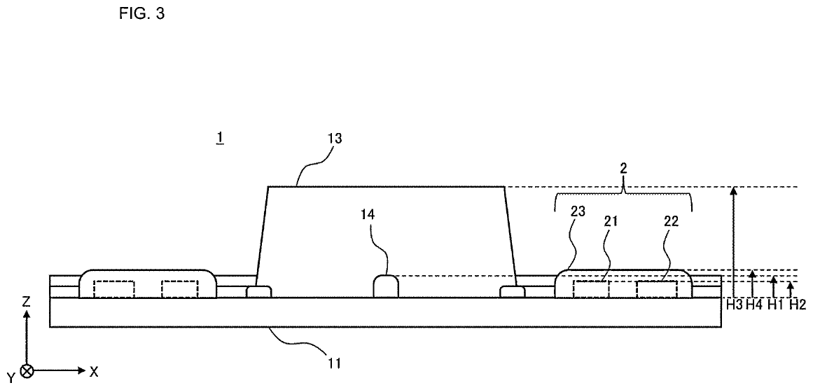

For example, as shown in FIG. 1, the sensor device 1 of the present preferred embodiment includes the substrate 11, the proximity sensor 12, the force sensor 13, and a light shielding body 14. FIG. 2 is a plan view of the sensor device 1 when viewed from the Z direction. FIG. 3 is a side view of the sensor device 1 when viewed from the Y direction.

In the sensor device 1 of the present preferred embodiment, as shown in FIG. 2, the first light receiving-emitting portion 2a to the fourth light receiving-emitting portion 2d of the proximity sensor 12 each include a corresponding one of a first light emitting element 21a to a fourth light emitting element 21d and a corresponding one of a first light receiving element 22a to a fourth light receiving element 22d. Hereunder, a general term for the first light receiving-emitting portion 2a to the fourth light receiving-emitting portion 2d is “light receiving-emitting portions 2”, a general term for the first light emitting element 21a to the fourth light emitting element 21d is “light emitting elements 21”, and a general term for the first light receiving element 22a to the fourth light receiving element 22d is “light receiving elements 22”.

In the sensor device 1 of the present preferred embodiment, each light receiving-emitting portion 2 of the proximity sensor 12 is a portion that is provided such that the light emitting element 21 and the light receiving element 22 are provided together as one unit.

Each light emitting element 21 includes, for example, a light source element, such as an LED (light emitting diode). For example, each light emitting element 21 emits light having a predetermined wavelength range, such as an infrared region (hereunder referred to as “detection light”). Each light emitting element 21 includes a light exiting surface from which the emitted detection light exits, and is disposed with the light exiting surface on the upper side.

Each light emitting element 21 is not limited to including an LED and may include, for example, various other types of solid light source elements, such as an LD (semiconductor laser) or a VCSEL (surface emitting laser). Each light emitting element 21 may include a plurality of light source elements. An optical system, such as a lens or a mirror, that collimates light coming from the light source elements may be provided at each light emitting element 21.

Each light receiving element 22 includes one or a plurality of light receivers, such as PDs (photodiodes), and has a light receiving surface including the one or the plurality of light receivers. Each light receiving element 22 receives, at its light receiving surface, light, such as reflected light, which is detection light reflected by the object 5, and generates, for example, a light reception signal that indicates, as a light reception result, the amount of received light.

Each light receiving element 22 is not limited to including a PD and may include, for example, various other types of light receivers, such as a phototransistor, a PSD (position detecting element), a CIS (CMOS image sensor), or a CCD. Each light receiving element 22 may be including a linear array or a two-dimensional array of light receivers. An optical system, such as a lens, for condensing the reflected light may be provided at each light receiving element 22. For example, a bandpass filter that blocks light of a wavelength range that differs from the wavelength range of detection light may be provided at the light receiving surface of each light receiving element 22. This makes it possible to reduce or prevent the effects of disturbance light resulting from an external environment.

In the sensor device 1 of the present preferred embodiment, with a central position p0, where the force sensor 13 is disposed on the substrate 11, being a reference, the plurality of light receiving-emitting portions 2a to 2d of the proximity sensor 12 are rotationally symmetrically disposed within a tolerance range as appropriate. In this case, the position of the center of gravity with respect to the positions where the plurality of light receiving-emitting portions 2a to 2d are disposed coincides with the central position p0 of the force sensor 13. For example, the position of the first light receiving-emitting portion 2a is on a +X side and a +Y side, the position of the second light receiving-emitting portion 2b is on a −X side and a +Y side, the position of the third light receiving-emitting portion 2c is on the −X side and a −Y side, and the position of the fourth light receiving-emitting portion 2d is on the +X side and the −Y side.

In the present preferred embodiment, the force sensor 13 is capable of using various types of force detection systems to detect a force from the object 5. Examples of the various types of force detection systems include a piezoelectric system, an optical system, a strain resistance system, and a capacitive system. The force sensor 13 detects multi-axial forces, such as three-axis forces or six-axis forces.

For example, as shown in FIG. 3, the force sensor 13 includes an upper surface that protrudes upward from the substrate 11. The upper surface of the force sensor 13 has, for example, a planar shape. The shape of the upper surface is not particularly limited thereto, and may be a curved shape. The force sensor 13 includes, as appropriate, a sensor element inside various types of exterior members that are deformable in accordance with a contact force, the sensor element corresponding to a force detection system that is to be used. The force sensor 13 may be a pressure sensor. A height H3 of the upper surface of the force sensor 13 is higher than the height of the light exiting surface of each light emitting element 21 and the height of the light receiving surface of each light receiving element 22.

As shown in, for example, FIGS. 1 to 3, the light shielding body 14 is provided so as to separate two light receiving-emitting portions 2 that are adjacent to each other. The light shielding body 14 includes, for example, an elastic body formed so as to extend from the force sensor 13. The light shielding body 14 has, for example, a transmissivity of about 10% or less with respect to detection light coming from each light emitting element 21. The light shielding body 14 can be made of various types of materials, such as silicone.

For example, the light shielding body 14 can be made of a material that is the same as the material of the exterior of the force sensor 13. By forming the light shielding body 14 integrally with the exterior of the force sensor 13, it is possible to easily produce the sensor device 1. For example, the light shielding body 14 may be a portion that functions as a runner when forming the exterior of the force sensor 13 by injection molding. The integral formation of the exterior of the force sensor 13 and the light shielding body 14 is not particularly limited to injection molding and may be, for example, transfer molding or compression molding.

For example, as shown in FIGS. 2 and 3, each light receiving-emitting portion 2 of the proximity sensor 12 further includes a sealing body 23 that seals the light emitting element 21 and the light receiving element 22, and that is made of, for example, a light-transmissive resin. Each sealing body 23 is formed by, for example, injection molding, and may have a portion that functions as a runner at the time of such molding. In the present preferred embodiment, a light-shielding portion is not particularly provided between the light emitting element 21 and the light receiving element 22 inside each light receiving-emitting portion 2. Therefore, it is possible to easily produce each light receiving-emitting portion 2 and to easily reduce the size thereof.

In the sensor device 1 of the present preferred embodiment, as shown in FIGS. 2 and 3, the light emitting element 21 of each light receiving-emitting portion 2 is disposed on an inner peripheral side of the light receiving element 22, that is, on a side near the force sensor 13. This makes it possible to bring profiles of light beams that exit from the light emitting elements 21 of different light receiving-emitting portions 2 close to each other and generally form one light profile peak. In addition, each light receiving element 22 is relatively disposed on an outer peripheral side, that is, on a side that is far from the force sensor 13. This makes it possible to decrease the elevation angle in which one looks upward toward the upper surface of the force sensor 13 from each light receiving element 22 and to make it easy to ensure an angle of view that allows each light receiving element 22 to receive light.

Therefore, in the sensor device 1 of the present preferred embodiment, proximity, in particular, direction can be easily detected with high precision. For example, as shown in FIG. 2, the direction of the object 5 is detected by detecting a direction angle ϕ that indicates the direction in the XY plane with the position of the center of gravity, such as the central position p0 of the force sensor 13, being a reference. From the viewpoint of increasing the precision of such a detection, in the sensor device 1, as shown in FIG. 2, the plurality of light emitting elements 21 and the plurality of light receiving elements 22 may each be disposed along a radial direction from the central position p0.

In the sensor device 1, for example, as shown in FIG. 3, a height H1 of the light shielding body 14 is greater than or equal to a height H2 of each of the light emitting elements 21 and a height H2 of each of the light receiving elements 22. Although FIG. 3 shows an example in which the height H2 of each of the light emitting elements 21 and the height H2 of each of the light receiving element 22 are the same, it is not particularly limited thereto. When the height of each of the light emitting elements 21 and the height of each of the light receiving elements 22 differ from each other, the height H1 of the light shielding body 14 is to be greater than or equal to, of the height of each element 21 and the height of each element 22, the larger one of the heights.

In addition, the height H1 of the light shielding body 14 is less than or equal to the height H3 of the force sensor 13. Therefore, a case in which elastic deformation in accordance with an external force of the force sensor 13 is hindered by the light shielding body 14 is easily prevented from occurring. Further, the height H1 of the light shielding body 14 may be less than or equal to a height H4 of the sealing body 23 of each light receiving-emitting portion 2.

Note that, in the sensor device 1 of the present preferred embodiment, the position of the center of gravity with respect to the positions where the plurality of light receiving-emitting portions 2a to 2d are disposed need not be the central position p0 of the force sensor 13 (FIG. 2), and may be within a range in which the force sensor 13 is disposed on the substrate 11. The position of the center of gravity above can be defined as, for example, the center of gravity with respect to the position of the first light emitting element 21a to the position of the fourth light emitting element 21d, and/or the position of the first light receiving element 22a to the position of the fourth light receiving element 22d in the XY plane on the substrate 11.

### 1-2. Controller of Sensor Device

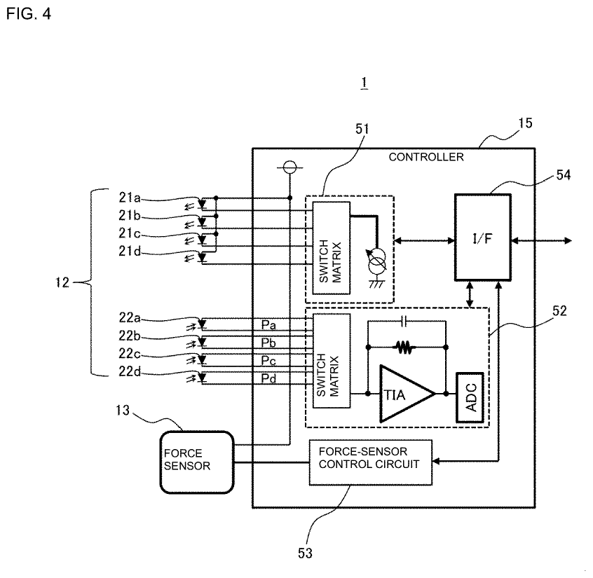

FIG. 4 is a circuit diagram that exemplifies an electrical structure of the sensor device 1 according to the present preferred embodiment. In addition to being structured as described above, the sensor device 1 of the present preferred embodiment may further include a controller 15 as shown in FIG. 4.

For example, as shown in FIG. 4, the controller 15 of the sensor device 1 includes a light-emission control circuit 51, a light-reception control circuit 52, a force-sensor control circuit 53, and an interface circuit 54. The controller 15 may further include an arithmetic processing circuit (not shown), such as an MCU.

The light-emission control circuit 51 includes, for example, a switch matrix that is connected to each light emitting element 21 and a light-source driving portion that is connected to each light emitting element 21 through the switch matrix. The light-source driving portion supplies a driving signal to each light emitting element 21, the driving signal causing detection light to be emitted. The light-emission control circuit 51 may include, for example, a modulator, such as an AM modulator. For example, the light-emission control circuit 51 may modulate detection light by using, for a modulation frequency that periodically varies the amplitude of light, a particular frequency in a range of, for example, about 10 Hz to about 1 MHz. By modulating the detection light, it becomes easy to distinguish the detection light and reflected detection light from disturbance light.

The light-reception control circuit 52 includes, for example, a switch matrix that is connected to each light receiving element 22, an amplifier that is connected to each light receiving element 22 through the switch matrix, and an A/D (analog/digital) converter that is connected to the amplifier. The light-reception control circuit 52 performs various types of signal processing operations on light reception signals Pa to Pd that are output from the respective light receiving elements 22a to 22d, and outputs them to, for example, the interface circuit 54.

The light-reception control circuit 52 may perform, for example, a filter processing operation of, for example, a bandpass filter that passes therethrough a signal component including the modulation frequency of detection light, or may perform synchronous detection in synchronism with the light-emission control circuit 51. For example, in the light-reception control circuit 52, by blocking a steady-state DC component, it is possible to separate the DC component from disturbance light and to analyze the aforementioned reflected light. The modulation frequency of the detection light can be set as appropriate while avoiding, for example, frequencies that are used in an existing external system, such as about 38 kHz that is used as a carrier of an infrared remote controller. This makes it possible to reduce or prevent malfunctions of the sensor device 1 caused by the external system.

The force-sensor control circuit 53 includes, for example, a control circuit that drivingly controls the sensor element in the force sensor 13, and an amplifier of an output signal coming from the sensor element. The force-sensor control circuit 53 may include, for example, a circuit structure that generates a force detection signal that indicates detection results of multi-axial forces on the basis of the aforementioned output signal. The force-sensor control circuit 53 may output a force detection signal of, not only the detection results of multi-axial forces, but also detection results of a uniaxial force.

For example, as long as the force detection system is a piezoelectric system, the piezoelectric effect of one or more piezoelectric elements disposed on the substrate inside the force sensor 13 is utilized, and stress produced inside the force sensor 13 due to contact by the object 5 (FIG. 1) is converted into an electric charge by the one or more piezoelectric elements, to perform sensing of a force on the basis of a change of the electric charge. When an optical system is used, one or more light emitting elements and one or more light receiving elements, all of which are disposed on the substrate inside the force sensor 13, are used, and changes in a reflected light distribution inside the force sensor 13 occurring as a result of deformation due to contact by the object 5 are read by the one or more light receiving elements, to perform sensing of a force. In a strain resistance system, one or more strain gauges that are disposed on the substrate inside the force sensor 13 are used, and, as a result of deformation due to contact by the object 5, strain that is transmitted to the one or more strain gauges through the inside of the force sensor 13 is determined as a resistance change, to perform sensing of a force by using this change. In a capacitive system, one or more capacitive detection electrodes that are disposed on the substrate inside the force sensor 13 are used, and, as a result of deformation of the force sensor 13 due to contact by the object 5, sensing of a force is performed on the basis of a coupling capacity change between the changing one or more capacitive detection electrodes and the reference potential. Note that, in each system, it becomes possible to multiaxially perform the sensing of forces by using a plurality of various types of sensor elements, such as piezoelectric elements, light receiving-emitting elements, strain gauges, or capacitive detection electrodes, disposed inside the force sensor 13.

The interface circuit 54 is connected to the light-emission control circuit 51, the light-reception control circuit 52, and the force-sensor control circuit 53. The interface circuit 54 performs input/output of various types of signals as a result of connecting the sensor device 1 to an external device.

Note that the structure described above is one example, and the sensor device 1 is not particularly limited to the above-described structure. For example, the sensor device 1 of the present preferred embodiment may be such that any one of the circuits 51 to 54 of the controller 15 is an external structure, or may be provided as a module that is separate from each of the circuits 51 to 54 of the controller 15.

### 2. Operation

An operation of the sensor device 1 that is structured as described above is described below.

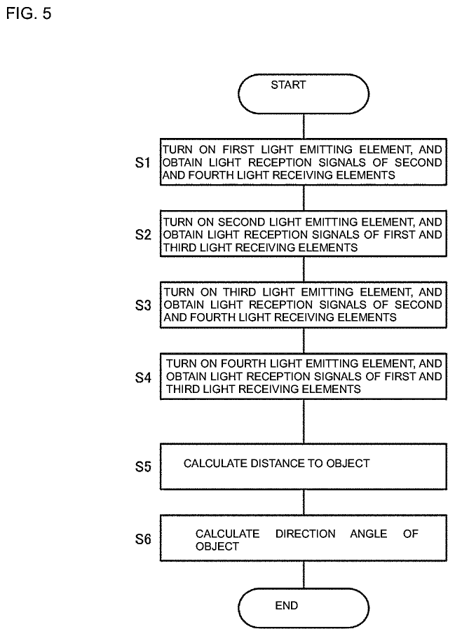

The sensor device 1 performs both detection of proximity of the object 5 and detection of a force of the object 5 at the same time by using the proximity sensor 12 and the force sensor 13 that are structured as described above. The sensor device 1 of the present preferred embodiment detects the distance and the direction angle ϕ (see FIG. 2) of the object 5 that has come close by successively using a light reception result of the light receiving element 22 inside a light receiving-emitting portion 2 differing from a light receiving-emitting portion 2 whose light emitting element 21 is emitting light among the plurality of light receiving-emitting portions 2a to 2d of the proximity sensor 12. An example of the operation of such a sensor device 1 is described by using FIG. 5.

FIG. 5 is a flowchart that exemplifies an operation of detecting proximity by the sensor device 1 of the present preferred embodiment. Hereunder, an example of performing control to turn on the light emitting element 21a of the first light receiving-emitting portion 2a to the light emitting element 21d of the fourth light receiving-emitting portion 2d of the proximity sensor 12 one at a time in turn is described.

For example, the controller 15 of the sensor device 1, first, controls each light emitting element 21 by using the light-emission control circuit 51 such that the first light emitting element 21a of the first light receiving-emitting portion 2a is turned on and the other light receiving-emitting portions 2b to 2d are turned off (S1). Here, the controller 15 obtains, at the light-reception control circuit 52, light-reception signals Pb and Pd of light reception results from the light receiving elements 22b and 22d of the respective second and fourth light receiving-emitting portions 2b and 2d that are adjacent to the first light receiving-emitting portion 21a (S1).

Similarly to the above, next, the controller 15 turns on only the second light emitting element 21b, and obtains light reception signals Pa and Pc from the respective first and third light receiving elements 22a and 22c (S2). Next, the controller 15 turns on only the third light emitting element 21c, and obtains light reception signals Pb and Pd from the respective second and fourth light receiving elements 22b and 22d (S3). Next, the controller 15 turns on only the fourth light emitting element 21d, and obtains light reception signals Pb and Pc from the respective first and third light receiving elements 22a and 22c (S4).

Next, on the basis of the light reception signals Pa to Pd obtained in each of Steps S1 to S4, the controller 15 performs an arithmetic operation by using the following Formula (1) to calculate distance information Pr indicating a detection result of a proximity distance of the object 5 (S5).

Pr=(P1+P2+P3+P4)^{1/2} (1)

In Formula (1) above, first light reception data P1 indicates a total value of the light reception signal Pa of the first light receiving element 22a when the second light emitting element 21b emits light (S2) and the light reception signal Pa of the first light receiving element 22a when the fourth light emitting element 21d emits light (S4). Second light reception data P2 indicates a total value of the light reception signal Pb of the second light receiving element 22b when the first light emitting element 21a emits light (S1) and the light reception signal Pb of the second light receiving element 22b when the third light emitting element 21c emits light (S3). Third light reception data P3 indicates a total value of the light reception signal Pc of the third light receiving element 22c when the second light emitting element 21b emits light (S2) and the light reception signal Pc of the third light receiving element 22c when the fourth light emitting element 21d emits light (S4). Fourth light reception data P4 indicates a total value of the light reception signal Pd of the fourth light receiving element 22d when the first light emitting element 21a emits light (S1) and the light reception signal Pd of the fourth light receiving element 22d when the third light emitting element 21c emits light (S3). By using an arithmetic formula, such as Formula (1) above, based on the total sum of the light reception data P1 to the light reception data P4, it is possible to detect the proximity distance of the object 5.

In addition, the controller 15 performs an arithmetic operation by using the following Formula (2) based on the first light reception data P1 to the fourth light reception data P4 above to calculate direction information Pϕ that indicates the direction angle ϕ of the object 5 (S6).

Pϕ=arctan(Py/Px) (2)

In Formula (2) above, arctan ( ) is an inverse function of the tan function, and Py and Px are each defined by a corresponding one of the next formulas.

Py=(P1+P4)−(P2+P3)

Px=(P1+P2)−(P3+P4)

By using Arithmetic Formula (2), such as the formula above, based on the differences between the light reception data P1 to the light reception data P4, it is possible to detect the direction angle ϕ of the object 5.

The controller 15 calculates the direction information Pϕ and the like (S6) to end the processing operations indicated in the present flowchart. For example, the controller 15 repeatedly executes the processing operations in the present flowchart in a predetermined detection period.

According to the processing operations above, the sensor device 1 uses a light reception result of the light receiving element 22 inside a light receiving-emitting portion 2 that is adjacent to a light receiving-emitting portion 2 whose light emitting element 21 is emitting light among the plurality of light receiving-emitting portions 2a to 2d (S1 to S4), and detects proximity of the object 5 (S5 and S6). That is, the light reception data P1 to the light reception data P4 for detecting proximity are redefined without using a light reception result of the light receiving element 22 inside a light receiving-emitting portion 2 whose light emitting element 21 is emitting light. Therefore, even if, due to direct optical coupling by the light emitting elements 21 and the light receiving elements 22 inside the light receiving-emitting portions 2, the light reception results of the light receiving elements 22 are saturated, it is possible to circumvent the effects of the saturation and to increase the precision of detecting proximity.

The direct optical coupling between the light emitting elements 21 and the light receiving elements 22 of the adjacent light receiving-emitting portions 2 can be reduced or prevented by the light shielding body 14. By such a light shielding body 14, it is possible to reduce base noise in the light reception signals Pa to Pd (and thus the light reception data P1 to the light reception data P4), ensure a dynamic range in the detection of the proximity distance and the detection of the direction angle ϕ (S5 and S6), and detect proximity with good precision.

Light reception results of the light receiving elements 22 of light receiving-emitting portions 2 that oppose each other with the force sensor 13 interposed therebetween among light receiving-emitting portions 2 whose light emitting elements 21 are emitting light in the plurality of light receiving-emitting portions 2a to 2d may be influenced by a shadow of the force sensor 13. Therefore, the light reception results of such a positional relationship are caused not to include redefined light reception data P1 to redefined light reception data P4 for performing arithmetic operations by using Formulas (1) and (2). Note that, when positively detecting a case in which the light receiving elements 22 are in the shadow of the force sensor 13, the light reception results for the aforementioned positional relationship may be used.

The operation example described above is one example, and the operation of detecting proximity by the sensor device 1 of the present preferred embodiment is not particularly limited thereto. For example, although, in the description above, an example in which control is performed to cause the first light emitting element 21a to the fourth light emitting element 21d to emit light one at a time in turn is described, the order in which each of the light emitting elements 21a to 21d is turned on may be an order that differs from the order in Step S1 to Step S4 in FIG. 5.

The control of the turning on of the light emitting elements 23 is not limited to a case in which the light emitting elements are turned on one at a time, and may be, for example, a case in which the light emitting elements are turned on two at a time. For example, the sensor device 1 may be perform Steps S1 and S3 above at the same time, and may perform Steps S2 and S4 above at the same time. Even in such cases, it is possible to cause each of the light emitting elements 2 to be successively turned on without causing all of the plurality of light emitting elements 21a to 21d to emit light at the same time, and to obtain information similar to the aforementioned light reception data P1 to the aforementioned light reception data P4.

The control of each of the light receiving-emitting portions 2a to 2d as in Steps S1 to S4 is not necessarily time-division control. Various types of control that allow information similar to the aforementioned light reception data P1 to the aforementioned light reception data P4 to be obtained are applicable, and thus, for example, control, such as frequency modulation control, which allows light reception results of detection light beams coming from the respective light emitting elements 21a to 21d to be divided, may be applied as appropriate.

### 3. Summary

As described above, the sensor device 1 of the present preferred embodiment includes a substrate 11, a force sensor 13 that is provided on the substrate 11, and a proximity sensor 12. The proximity sensor 12 includes a plurality of light emitting elements 21 that are provided on the substrate 11 and a plurality of light receiving elements 22 that receive light from the light emitting elements 21. At least one of the plurality of light emitting elements 21 and the plurality of light receiving elements 22 of the proximity sensor 12 is disposed at three or more positions that surround the force sensor 13 on the substrate 11. The position of the center of gravity with respect to the three or more positions is within a range in which the force sensor 13 is positioned on the substrate 11 (see FIG. 2).

According to the sensor device 1 above, by using the light emitting elements 21 and/or the light receiving elements 22 provided at the three or more positions around the force sensor 13, it is possible to detect in a seamless manner a process in which the object 5 comes close to and contacts the sensor device 1 from various directions. Therefore, the sensor device 1 is capable of, in addition to detecting a force of a physical object, such as the object 5, easily detecting a close physical object in various directions.

In the sensor device 1 of the present preferred embodiment, the proximity sensor 12 includes three or more light receiving-emitting portions 2 disposed at three or more positions. Each light receiving-emitting portion 2 includes a light emitting element 21 and a light receiving element 22. Therefore, proximity of the object 5 is easily detected in various directions by, for example, emitting/receiving light between the light receiving-emitting portions 2 disposed around the force sensor 13. In addition, by providing the light emitting element 21 and the light receiving element 22 together in each light receiving-emitting portion 2, it is possible to easily produce the sensor device 1. The sensor device 1 of the present preferred embodiment further includes a light shielding body 14 provided between the three or more light receiving-emitting portions 2 on the substrate 11. By using the light shielding body 14, it is possible to reduce or prevent direct optical coupling between the light receiving-emitting portions 2 where reflection of light by the object 5 is not made use of. Therefore, it is possible to ensure a dynamic range in various types of detection by the proximity sensor 12 and to increase detection precision.

In the sensor device 1 of the present preferred embodiment, the light shielding body 14 is made of a material whose transmissivity with respect to light that each light emitting element 21 emits is 10% or less. By using such a light shielding body 14, it is possible to reduce or prevent direct optical coupling between the light receiving-emitting portions 2 and to increase detection precision of the sensor device 1.

In the sensor device 1 of the present preferred embodiment, the height of the light shielding body 14 from the substrate 11 is greater than or equal to the height of each light emitting element 21 and is greater than or equal to the height of each light receiving element 22. By using such a light shielding body 14, it is possible to reduce or prevent direct optical coupling between the light emitting elements 21 and the light receiving elements 22 of different light receiving-emitting portions 2 and to increase detection precision of the sensor device 1.

In the sensor device 1 of the present preferred embodiment, the height of the force sensor 13 from the substrate 11 is greater than or equal to the height of each light emitting element 21 and is greater than or equal to the height of each light receiving element 22, and the height of the light shielding body 14 is less than or equal to the force sensor 13. Therefore, it is possible to prevent a case in which detection of a force by, for example, elastic deformation of the force sensor 13 is hindered by the light shielding body 14, and to easily perform both detection of proximity of the object 5 and detection of a force of the object 5.

In the sensor device 1 of the present preferred embodiment, each light receiving-emitting portion 2 includes a sealing body 23 that seals the light emitting element 21 and the light receiving element 22. The height of each light shielding body 14 from the substrate 11 is less than or equal to the height of each sealing body 23. Therefore, it is possible to prevent the height of the light shielding body 14 from becoming too high and to easily perform both detection of proximity of the object 5 and detection of a force of the object 5.

In the sensor device 1 of the present preferred embodiment, the light shielding body 14 is made of a material that is the same as the material of the exterior of the force sensor 13, and is connected to the force sensor 13. Such a light shielding body 14 can, for example, be integrally formed with the exterior of the force sensor 13 and make it possible to easily produce the sensor device 1.

In the sensor device 1 of the present preferred embodiment, the positions of the three or more light receiving-emitting portions 2 are rotationally symmetrical around the position of the center of gravity as the center. Such light receiving-emitting portions 2 are capable of detecting the direction angle ϕ of the object 5 with good precision.

In the proximity sensor 12 of the sensor device 1 of the present preferred embodiment, the light emitting elements 21 are disposed closer than the light receiving elements 22 to the force sensor 13. Therefore, even though the light emitting elements 21 and the light receiving elements 22 are disposed around the force sensor 13, it is possible to ensure the angle of view of each light receiving element 22 while putting together the optical profiles of the light emitting elements 21 and to easily detect proximity of the object 5.

In the proximity sensor 12 of the sensor device 1 of the present preferred embodiment, the plurality of light emitting elements 21 and the plurality of light receiving elements 22 are radially disposed from the position of the center of gravity. Therefore, the proximity sensor 12 is capable of detecting the direction angle ϕ of the object 5 with good precision.

The sensor device 1 of the present preferred embodiment further includes a controller 15 that detects the direction of the object 5 from the sensor device based on light reception results obtained when, in the proximity sensor 12, the plurality of light receiving elements 22 receive light emitted from the plurality of light emitting elements 21 and reflected from the object 5. Therefore, the controller 15 of the sensor device 1 is capable of detecting the direction of the object 5.

In the sensor device 1 of the present preferred embodiment, the controller 15 detects the distance from the sensor device to the object 5 by using Arithmetic Formula (1) based on the total sum of light reception results provided by the plurality of light receiving elements 22 (S5). The controller 15 detects the direction of the object 5 from the sensor device by using Arithmetic Formula (2) based on differences between the light reception results provided by the plurality of light receiving elements 22 (S6). The controller 15 is capable of detecting the distance up to the object 5 or the direction of the object 5 not only by using Arithmetic Formulas (1) and (2) above, but also by various other types of arithmetic processing operations based on the total sum of the plurality of light reception results or the differences between the plurality of light reception results.

In the sensor device 1 of the present preferred embodiment, the controller 15 causes each light emitting element 21 to successively emit light without causing all of the plurality of light emitting elements 21 to emit light at the same time (S1 to S4). By performing such light emission control, it is possible to reduce or prevent saturation of at least one light receiving element 22 and to easily detect proximity of the object 5 by using the light reception result of the least one light receiving element 22.

### Second Preferred Embodiment

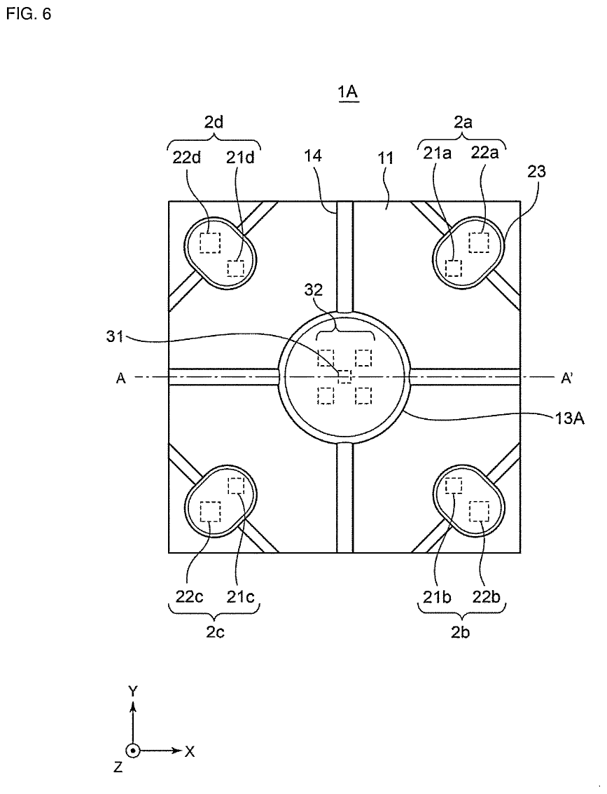

In a second preferred embodiment, an example in which an optical system is used as a force detection system is described by using FIGS. 6 to 8.

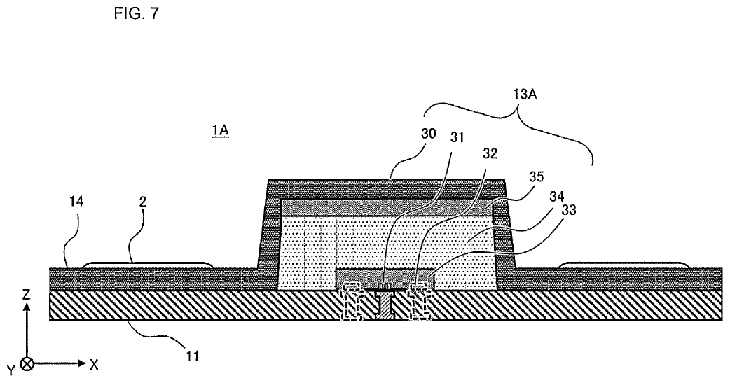

FIG. 6 is a plan view of a sensor device 1A according to the second preferred embodiment. FIG. 7 is a sectional view of the sensor device 1A in a cross section along A-A′ in FIG. 6. The cross section along A-A′ is a cross section that passes through a central position p0 of a force sensor 13A along an XZ plane.

In the sensor device 1A of the present preferred embodiment, for example, the force sensor 13A includes an optical system in a structure that is similar to the structure of the sensor device 1 of the first preferred embodiment. For example, as shown in FIG. 6, the optical force sensor 13A includes a light emitting element 31 and a light receiving element 32. Further, as shown in FIG. 7, the force sensor 13A includes elastic bodies 33 and 34, a reflecting body 35, and an exterior member 30.

In the optical force sensor 13A, the light emitting element 31 includes, for example, a light-emitting light source, such as a VCSEL, which is a single-emitter VCSEL or a multi-emitter VCSEL. For example, the light emitting element 31 emits light having a predetermined wavelength range, such as an infrared region, and causes the light to exit as detection light. The light emitting element 31 is not limited to a VCSEL, and may include, for example, various other types of solid-state light source elements, such an LD or LED. The light emitting element 31 may include a plurality of light source elements. An optical system, such as a lens or a mirror, that collimates light coming from the light emitting element may be provided at the light emitting element 31.

The light receiving element 32 may include a plurality of light receivers, such as PDs, and includes, for example, disposing the plurality of light receivers around the light emitting element 31. The light receiving element 32 receives light, such as reflected detection light, at the light receivers, and, for example, generates a light reception signal indicating the amount of received light as a light reception result. The light receiving element 32 is not limited to including PDs, and may include, for example, various other types of light receivers, such as phototransistors, PSDs, CISs, or CCDs.

The elastic bodies 33 and 34 define, for example, a two-layer structure. The elastic body 33 of the first layer is made of, for example, a relatively hard resin, and seals the light emitting element 31 and the light receiving element 32. The elastic body 34 of the second layer is made of, for example, a resin that is softer than the resin of the elastic body 33 of the first layer, and seals the elastic body 33 of the first layer. Each of the elastic bodies 33 and 34 is made of, for example, a resin having light transmissivity with respect to a frequency band of detection light emitted by the light emitting element 31. Note that the elastic bodies of the force sensor 13A are not limited to defining a two-layer structure, and may define one layer or three or more layers.

The reflecting body 35 is made of, for example, a resin having a reflection characteristic with respect to the frequency band of detection light emitted by the light emitting element 31. The reflecting body 35 is provided on, for example, the elastic body 34 of the second layer. Note that, when, for example, the exterior member 30 has the reflection characteristic above, the reflecting body 35 may be omitted.

The exterior member 30 includes, for example, an elastic member having a light-shielding characteristic with respect to the frequency band of detection light emitted by the light emitting element 31. In the present preferred embodiment, the exterior member 30 of the force sensor 13A can be integrally formed with the light shielding body 14 as in the first preferred embodiment.

In the optical force sensor 13A that is structured as described above, the detection light that is emitted from the light emitting element 31 detects the contact force of the object 5 in accordance with the force from the object 5 that comes into contact with the force sensor 13A by making use of the fact that the light reception state of the light receiving element 32 with respect to reflection light reflected by the reflecting body 35 changes. As a method of measuring the contact force by an optical system, a related-art technology is applicable as appropriate (see, for example, Japanese Unexamined Patent Application Publication No. 2007-071564, Japanese Patent No. 5825604 and International Publication No. 2014/045685).

According to such an optical force sensor 13A, since the force sensor 13A can be made together with a proximity sensor 12 by using a production process that is the same as that of the proximity sensor 12, it is possible is easily produce the sensor device 1A. For example, a sealing body 23 of each light receiving-emitting portion 2 of the proximity sensor 12 and the elastic body 33 that seals the light emitting element 31 and the light receiving element 32 of the force sensor 13A may be formed by the same process.

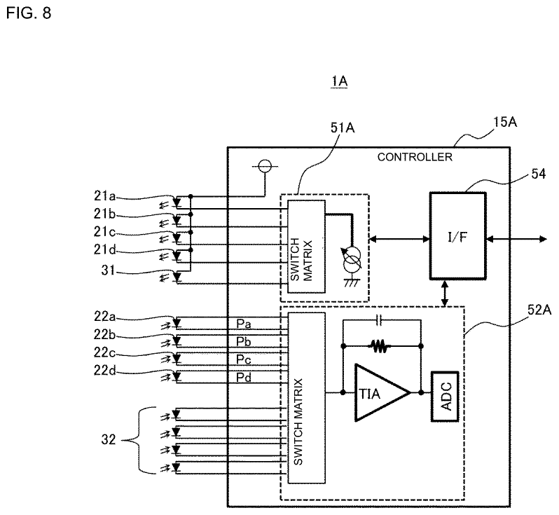

FIG. 8 is a circuit diagram that exemplifies an electrical structure of the sensor device 1A according to the second preferred embodiment. In the first preferred embodiment, in the controller 15 of the sensor device 1, the force-sensor control circuit 53 is formed separately from the light-emission control circuit 51 and the light-reception control circuit 52 for controlling the proximity sensor 12. In a structure that is similar to that of the first preferred embodiment, instead of using the separate force-sensor control circuit 53 (FIG. 4), a controller 15A of the sensor device 1A of the present preferred embodiment is such that a light-emission control circuit 51A and a light-reception control circuit 52A of the proximity sensor 12 are provided with control functions of the force sensor 13A.

For example, as shown in FIG. 8, the light-emission control circuit 51A of the present preferred embodiment is configured or programmed to control the light emitting element 31 of the force sensor 13A together with light emitting elements 21 of the proximity sensor 12. In addition, the light-reception control circuit 52A of the present preferred embodiment is configured or programmed to control the light receiving element 32 of the force sensor 13A together with light receiving elements 22 of the proximity sensor 12. This makes it possible to provide the control function for both of the proximity sensor 12 and the force sensor 13A by using the same circuit technology, to decrease the number of components of the sensor device 1A, and to facilitate integration of the circuit.

For example, the controller 15A of the sensor device 1A of the present preferred embodiment can be including, for example, a single IC in which the control function of the proximity sensor 12 and the control function of the force sensor 13A are common. In this way, it is possible to reduce the size and cost of the sensor device 1A of the present preferred embodiment.

As described above, in the sensor device 1A of the present preferred embodiment, the optical force sensor 13A includes a light emitting element 31 that is separate from the light emitting elements 21 of the proximity sensor 12, and a light receiving element 32 that is separate from the light receiving elements 22 of the proximity sensor 12. The controller 15A includes a light-emission control circuit 51A that controls the light emitting elements 21 of the proximity sensor 12 and the light emitting element 31 of the force sensor 13A, and a light-reception control circuit 52A that controls the light receiving elements 22 of the proximity sensor 12 and the light receiving element 32 of the force sensor 13. By providing the proximity sensor 12 and the force sensor 13A of the sensor device 1A by using optical systems, it is possible to, in addition to facilitating the production of the sensor structure, simplify the circuit structure and to facilitate the production of the sensor device 1A.

### Other Preferred Embodiments

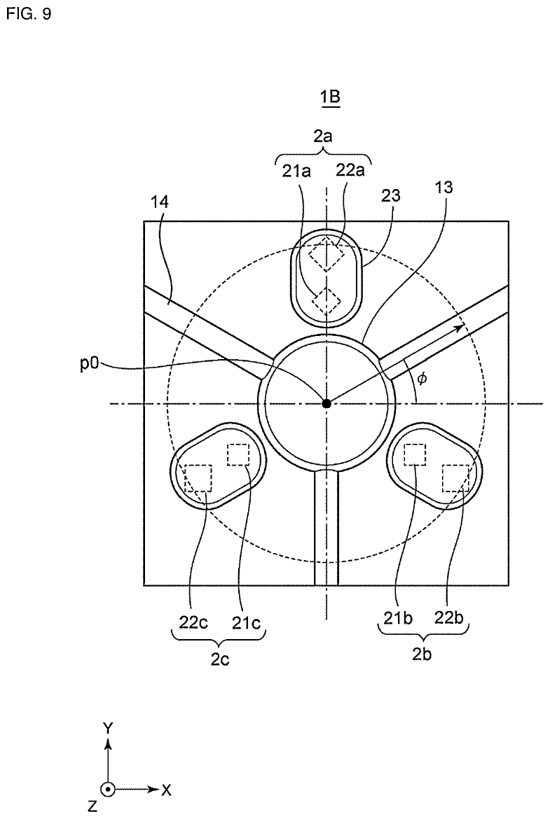

Although, in the first and second preferred embodiments above, an example in which the number of light receiving-emitting portions 2 of the proximity sensor 12 of the sensor device 1 is four is described, the sensor device 1 is not limited thereto. A modification is described by using FIG. 9.

FIG. 9 is a plan view of a sensor device 1B of Modification 1. In the present preferred embodiment, the number of light receiving-emitting portions 2 of the sensor device 1B may be three or more. As shown in FIG. 9, the sensor device 1B of the present modification includes three light receiving-emitting portions 2a, 2b, and 2c in a structure that is similar to that of the first preferred embodiment. Each of the light receiving-emitting portions 2a to 2c is the same as or similar to the light receiving-emitting portions 2 of the first preferred embodiment. As shown in FIG. 9, light emitting elements 21a to 21c and light receiving elements 22a to 22c are disposed rotationally symmetrically and radially within a tolerance as appropriate.

In the sensor device 1B of the present modification, distance information Pr is obtained by using the following Formula (11) instead of Arithmetic Formula (1) for the distance information Pr of the first preferred embodiment.

Pr=(P1′+P2′+P3′)_{1/2} (11)

In Formula (11) above, first light-reception data P1′ indicates a total value of a light reception signal Pa of the first light receiving element 22a when the second light emitting element 21b emits light and a light reception signal Pa of the first light receiving element 22a when the third light emitting element 21c emits light. Second light reception data P2′ indicates a total value of a light reception signal Pb of the second light receiving element 22b when the first light emitting element 21a emits light and a light reception signal Pb of the second light receiving element 22b when the third light emitting element 21c emits light (S3). Third light reception data P3′ indicates a total value of a light reception signal Pc of the third light receiving element 22c when the second light emitting element 21b emits light and a light reception signal Pc of the third light receiving element 22c when the first light emitting element 21a emits light.

Further, in the sensor device 1B of the present modification, direction information Pϕ is obtained by a calculation performed by using the next Formula (12) based on the first light reception data P1′ to the third light reception data P3′ instead of by the calculation using Arithmetic Formula (1) for the direction information Pϕ for the first preferred embodiment.

Pϕ=arctan(Py′/Px′) (12)

In Formula (12) above, Py′ and Px′ are each defined by a difference between corresponding ones of the light reception data P1′ to the light reception data P3′ as in a corresponding one of the next formulas.

Py′=P1′−(P2′+P3′)/2

Px′=P2′−P3′

In each of the preferred embodiments above, a sensor device 1 in which the proximity sensor 12 includes light receiving-emitting portions 2 each including a light emitting element 21 and a light receiving element 22 has been described. In the present preferred embodiments, the proximity sensor 12 of the sensor device 1 need not include light receiving-emitting portions 2. For example, the light emitting elements 21 and the light receiving elements 22 of the proximity sensor 12 may be separately disposed on the substrate 11. Even in this case, as long as at least one of the plurality of light emitting elements 21 and the plurality of light receiving elements 22 is disposed at three or more positions around the force sensor 13, it is possible to detect the direction of the object 5 with the position of the force sensor 13 as a reference.

As described above, in the sensor device of each of the present preferred embodiments, at least one of the plurality of light emitting elements 21 and the plurality of light receiving elements 22 of the proximity sensor 12 may be positioned at three or more positions around the force sensor 13 on the substrate 11, and the position of the center of gravity with respect to the three or more positions may be any of various positions within a range in which the force sensor 13 is positioned on the substrate 11. Even in such a sensor device, as in the first preferred embodiment, it is possible to, in addition to detecting a force of a physical object, such as the object 5, easily detect a close physical object in various directions.

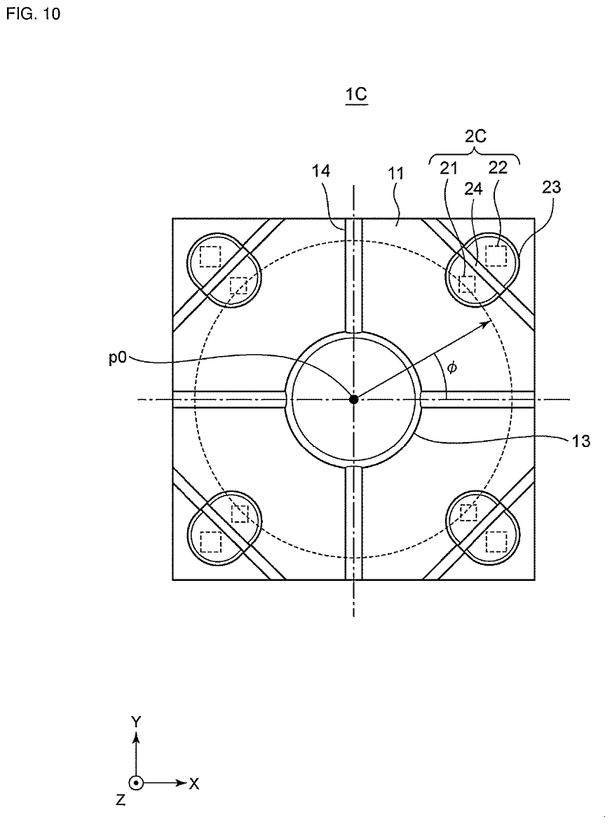

Although, in each of the preferred embodiments above, a sensor device 1 in which light shielding portions are not particularly provided inside the light receiving-emitting portions 2 has been exemplified, the light receiving-emitting portions 2 are not particularly limited thereto. A modification is described by using FIG. 10.

FIG. 10 is a plan view of a sensor device 1C according to Modification 2. In the sensor device 1C of the present modification, for example, in a structure that is similar to that of the first preferred embodiment, for example, a wall-like light shielding portion 24 is provided between the light emitting element 21 and the light receiving element 22 inside each light receiving-emitting portion 2C. Such light shielding portions 24 can each be including a light-transmissive member as appropriate. According to the sensor device 1C of the present modification, since direct light is blocked between the light emitting element 21 and the light receiving element 22 inside each light receiving-emitting portion 2C, even if a light reception result of the light receiving element 22 inside a light receiving-emitting portion 2C whose light emitting element 21 is emitting light is used, it is possible to detect proximity of the object 5 with good precision.

As described above, in the sensor device 1C of the present preferred embodiment, each light receiving-emitting portion 2C may include a light shielding portion 24 that is provided between the light emitting element 21 and the light receiving element 22 and that blocks light coming from the light emitting element 21. Even this makes it possible to, in addition to detecting a force of a physical object, easily detect a close physical object in various directions as in each of the preferred embodiments above.

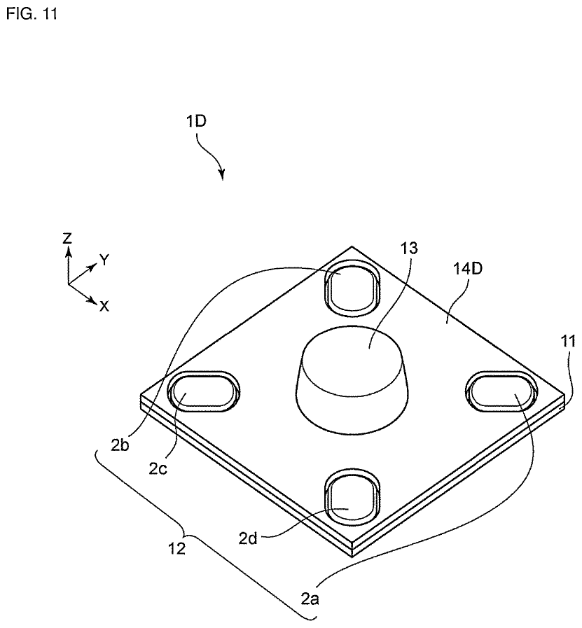

Although, in each of the preferred embodiments above, an example of the shape of the light shielding body 14 of the sensor device 1 has been described, the shape of the light shielding body 14 is not particularly limited thereto, and can be any other various shapes. A modification is described by using FIG. 11.

FIG. 11 is a plan view of a sensor device 1D according to Modification 3. In the sensor device 1D of the present modification, for example, in a structure that is similar to that of the first preferred embodiment, a light shielding body 14D is provided so as to cover a front surface of the substrate 11. Even such a light shielding body 14D makes it possible to prevent direct optical coupling between adjacent light receiving-emitting portions 2 and to obtain effects that are the same as those of each of the preferred embodiments above.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A sensor device comprising:
a substrate;
a force sensor on the substrate; and
a proximity sensor that includes a plurality of light emitting elements on the substrate and a plurality of light receiving elements to receive light from the light emitting elements; wherein
at least one of the plurality of light emitting elements and the plurality of light receiving elements of the proximity sensor is located at three or more positions that surround the force sensor on the substrate; and
a position of a center of gravity with respect to the three or more positions is within a range in which the force sensor is positioned on the substrate.

2. The sensor device according to claim 1, wherein
the proximity sensor includes three or more light receiving-emitting portions at the three or more positions; and
each of the light receiving-emitting portions includes a corresponding one of the light emitting elements and a corresponding one of the light receiving elements.

3. The sensor device according to claim 2, further comprising:
a light shielding body between the three or more light receiving-emitting portions on the substrate.

4. The sensor device according to claim 3, wherein the light shielding body is made of a material with a transmissivity with respect to light emitted from the light emitting elements that is about 10% or less.

5. The sensor device according to claim 3, wherein a height of the light shielding body from the substrate is greater than or equal to a height of each of the light emitting elements and is greater than or equal to a height of each of the light receiving elements.

6. The sensor device according to claim 5, wherein
a height of the force sensor from the substrate is greater than or equal to the height of each of the light emitting elements and is greater than or equal to the height of each of the light receiving elements; and
the height of the light shielding body is less than or equal to the height of the force sensor.

7. The sensor device according to claim 3, wherein
each of the light receiving-emitting portions includes a sealing body that seals a corresponding one of the light emitting elements and a corresponding one of the light receiving elements; and
a height of the light shielding body from the substrate is less than or equal to a height of each of the sealing bodies.

8. The sensor device according to claim 3, wherein the light shielding body is made of a material that is same as a material of an exterior of the force sensor, and is connected to the force sensor.

9. The sensor device according to claim 2, wherein the positions of the three or more light receiving-emitting portions are rotationally symmetrical around the position of the center of gravity as a center.

10. The sensor device according to claim 2, wherein each of the light receiving-emitting portions includes a light shielding portion that is provided between the corresponding one of the light emitting elements and the corresponding one of the light receiving elements, and blocks light from the corresponding one of the light emitting elements.

11. The sensor device according to claim 1, wherein, in the proximity sensor, the light emitting elements are closer than the light receiving elements to the force sensor.

12. The sensor device according to claim 11, wherein, in the proximity sensor, the plurality of light emitting elements and the plurality of light receiving elements are radially positioned relative to the position of the center of gravity.

13. The sensor device according to claim 1, further comprising:
a controller to detect a direction of a physical object from the sensor device based on light reception results obtained when, in the proximity sensor, the plurality of light receiving elements receive light emitted from the plurality of light emitting elements and reflected from the physical object.

14. The sensor device according to claim 13, wherein the controller is configured or programmed to:
detect a distance from the sensor device to the physical object based on a total sum of the light reception results provided by the plurality of light receiving elements; and
detect the direction of the physical object from the sensor device based on a difference between the light reception results provided by the plurality of light receiving elements.

15. The sensor device according to claim 13, wherein the controller is configured or programmed to cause each of the light emitting elements to successively emit light without causing all of the plurality of light emitting elements to emit light at a same time.

16. The sensor device according to claim 13, wherein
the force sensor includes a light emitting element that differs from the light emitting elements of the proximity sensor and a light receiving element that differs from the light receiving elements of the proximity sensor; and
the controller includes:
a light-emission control circuit to control the light emitting elements of the proximity sensor and the light emitting element of the force sensor; and
a light-reception control circuit to control the light receiving elements of the proximity sensor and the light receiving element of the force sensor.

17. The sensor device according to claim 1, wherein each of the plurality of light emitting elements is one of a light emitting diode, a semiconductor laser, or a surface emitting laser.

18. The sensor device according to claim 1, wherein each of the plurality of light receiving elements is one of a photodiode, a phototransistor, a position detector, a CMOS image sensor or a charge coupled device.

19. The sensor device according to claim 1, further comprising a bandpass filter to block light of a wavelength range different from a wavelength range of detection light.

20. The sensor device according to claim 1, wherein the force sensor uses a force detection system that is one of a piezoelectric system, an optical system, a strain resistance system, and a capacitive system.
